(19) United States
(12) Patent Application Publication
(10) Pub. No.: US 2025/0360651 A1
(43) Pub. Date: Nov. 27, 2025

(54) METHODS, SYSTEMS, AND DEVICES FOR CREATING A CONCRETE FIRE FEATURE BY PRESSURIZING A MOLD

(71) Applicant: Solo Brands, LLC, Grapevine, TX (US)

(72) Inventors: Lenny Vainberg, Laguna Hills, CA (US); Benjamin Lemus Gonzalez, Tecate Baja California (MX)

(21) Appl. No.: 18/671,395

(22) Filed: May 22, 2024

(51) Int. Cl. B28B 1/50; C04B 14/28; C04B 40/00; C04B 40/02

(52) U.S. Cl. CPC B28B 1/50; C04B 14/285; C04B 40/0042; C04B 40/0259

(57) ABSTRACT

Methods and systems for creating a concrete fire feature with a mold include creating an aggregate mixture by combining a first mixture with an average grain size within a first range and a second mixture with an average grain size within a second range, the aggregate mixture comprising about 5% quartz or less. The methods and systems also include creating a dry mixture comprising an aggregate mixture proportion of the aggregate mixture and a water proportion of water, the water proportion comprising about 15% or less of the dry mixture. The dry mixture is pressurized to create a formed main body having an outer surface with a porosity of about 40% or less. The main body is cured outside the mold, and a fuel can is secured at least partially inside the hole.

### TECHNICAL FIELD

The present disclosure relates generally to concrete fire features such as fire bowls, fireplaces, fire pits, stoves, ovens, fire tables, fire columns, chimineas, and other fire-containing devices, and more particularly to methods, systems, and devices for creating a concrete fire feature by pressurizing a mold.

### BACKGROUND

Fire features may be created from concrete poured into a mold. A concrete fire feature may be preferred over other types of fire features for aesthetic appearance, cost effectiveness, and durability. Concrete fire features are generally manufactured using a pour cast process. A pour cast process may include mixing a high-slump concrete, wetting the concrete, and pouring the concrete into a soft, solid, or hybrid mold. However, due to the substantial length of time generally required for concrete to set, a mold may only be able to produce one concrete piece each day. This substantially long setting period may significantly diminish overall potential manufacturing capacity per day and/or may increase manufacturing costs. Thus, there remains a need for effective ways to create a concrete fire feature from a mold.

### SUMMARY

Embodiments of the present disclosure include systems, devices, and methods of creating a concrete fire feature by pressurizing a mold.

In some examples, a method of creating a concrete fire feature with a mold may include creating an aggregate mixture by combining a first mixture with an average grain size within a first range and a second mixture with an average grain size within a second range, the aggregate mixture comprising about 5% quartz or less. The method may further include creating a dry mixture comprising an aggregate mixture proportion of the aggregate mixture, a cement proportion of cement, and a water proportion of water, the water proportion comprising about 15% or less of the dry mixture. The method may further include pressurizing the dry mixture to create a formed main body having an outer surface with a porosity of about 40% or less, the formed main body comprising a top surface, a bottom surface, and a hole extending inwardly from the top surface or the bottom surface. The method may further include curing the formed main body outside the mold. The method may further include securing a fuel can at least partially inside the hole.

In some examples, a method of creating a concrete fire feature may include creating an unrefined mixture comprising a proportion of limestone and a proportion of marble. The method may further include removing grains outside a first grain-size range from the unrefined mixture to obtain a first mixture, the first mixture comprising no more than 5% quartz. The method may further include removing grains outside a second grain-size range from the unrefined mixture to obtain a second mixture, the second mixture comprising no more than 5% quartz. The method may further include creating a dry mixture comprising a proportion of the first mixture, a proportion of the second mixture, a proportion of cement, and a proportion of water, the proportion of water comprising no more than 10% of the dry mixture. The method may further include applying pressure to the dry mixture in a mold to create a formed main body, the formed main body having a smooth outer surface with an average peripheral hole size of less than ⅛ inches, the formed main body comprising a top surface, a bottom surface, and a hole extending inwardly from the top surface or the bottom surface. The method may further include curing the formed main body outside the mold. The method may further include securing a fuel can at least partially inside the hole.

In some examples, a method of creating a concrete fire feature with a mold may include creating an aggregate mixture by combining a first mixture with an average grain size within a first range and a second mixture with an average grain size within a second range, the aggregate mixture comprising a quartz proportion comprising no more than 5% quartz. The method may further include creating a dry mixture comprising an aggregate mixture proportion of the aggregate mixture, a cement proportion of cement, and a water proportion of water, the water proportion comprising no more than 10% of the dry mixture. The method may further include pressurizing the dry mixture to create a formed main body from the mold, the formed main body comprising a top surface, a bottom surface, and a hole extending inwardly from the top surface or the bottom surface. The method may further include determining that the formed main body does not have a smooth outer surface or a porosity of no more than 40%. The method may further include decreasing the average grain size in the first mixture or the second mixture. The method may further include reducing the quartz proportion or the water proportion in the dry mixture. The method may further include pressurizing the dry mixture to create a second formed main body.

Additional aspects, features, and advantages of the present disclosure will become apparent from the following detailed description.

### BRIEF DESCRIPTION OF THE DRAWINGS

The accompanying drawing figures incorporated in and forming a part of this specification illustrate several aspects of the disclosure, and together with the description, serve to explain the principles of the disclosure.

FIG. 1 is a perspective view of an example fire feature, according to some aspects of the present disclosure.

FIG. 2 is a top perspective view of an example formed main body, according to some aspects of the present disclosure.

FIG. 3 is a bottom perspective view of an example formed main body, according to some aspects of the present disclosure.

FIG. 4 is a section view of an example fire feature, according to some aspects of the present disclosure.

FIG. 5 is a perspective view of an example plate assembly, according to some aspects of the present disclosure.

FIG. 6 is a perspective view of an example fuel can assembly, according to some aspects of the present disclosure.

FIG. 7 is an illustrative method for creating a concrete fire feature from a mold, according to some aspects of the present disclosure.

FIG. 8 is a perspective view of an example press, according to some aspects of the present disclosure.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

Disclosed herein are methods, systems, and devices for creating a concrete fire feature by using high pressure casting. The present disclosure allows for a potentially significant reduction in the setting period of a concrete fire feature, thereby potentially decreasing production time and production costs.

A pour cast process, which may include mixing a high-slump concrete, wetting the concrete, and pouring the concrete into a mold, may generally require a substantial length of time for the concrete to set. This substantially long setting period may significantly diminish possible manufacturing capacity per day and/or may increase manufacturing costs. This disclosed method and/or system may potentially reduce setting time of a concrete fire feature by applying high pressure casting to a mold. High pressure casting may, in some implementations, be referred to as hyperpressing.

Concrete, produced in a pour cast mold, generally sets and/or hardens after a substantial time period (i.e., more than a day) as a result of a chemical reaction of the ingredients and a gradual drying of the initially wet mixture. This disclosed method and/or system may potentially allow for a formed main body of the concrete fire feature to set and/or harden within a short time period, such as 1 to 20 seconds. In some implementations, an initial mixture may be dry such that the drying time of the concrete is significantly reduced. In some implementations, an initial mixture may be configured with properties such that it may set more quickly, and it may have a higher quality surface finish. In some implementations, a press may apply significant pressure to an initial mixture such that the mixture sets and/or hardens within a short time period and the resulting formed main body has a higher quality surface finish. Thus, a mold, used in manufacturing, may be able to produce a large number of concrete pieces per day, significantly more than a pour cast mold.

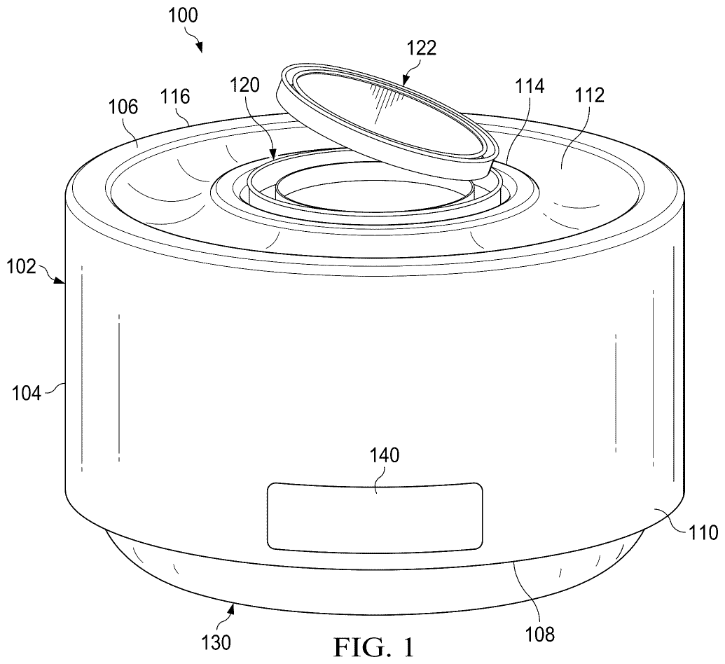

FIG. 1 is a perspective view of an example fire feature 100, according to some aspects of the present disclosure. The fire feature 100 may be produced using method(s) described further herein. The fire feature 100 may include a formed main body 102. The formed main body 102 may consist of concrete. The formed main body 102 may include a top surface 106 and a bottom rim 108. In some implementations, the formed main body 102 may further include a cylindrical body 104 such that a cross-section of the formed main body 102 may be circular. It should be understood that the formed main body 102 may include a body of any shape which may include a cross-section of any shape such as an ellipse, triangle, square, rectangle, hexagon, dodecagon, polygon, and/or irregular shape. The formed main body 102 may include an exterior side surface 110 which may extend along at least a portion of the sides of the formed main body 102. The exterior side surface 110 may be any length and/or width. The top surface may be positioned at the top of the formed main body 102 and, in some implementations, the cylindrical body 104. Thus, the top surface may be substantially or wholly perpendicular to the exterior side surface 110.

The top surface may include a recess 112 which may be a curved trough extending in an arch some radius away from the center of the top surface 106. Depending on the implementation, the recess 112 may be any size, shape, and/or position. For example, in some implementations, the recess may be a semi-circular trough, a rectangular trough, a triangular trough, or any other shaped trough. The recess 112 may be configured to receive embers and/or any other type of debris such as when the fire feature 100 is in operation. An inner rim 114 may be positioned at least partially between the recess 112 and the center of the top surface 106. The inner rim 114 may be flat, curved, and/or any other size, shape, and/or position. The inner rim 114 may extend along an inner perimeter of the recess 112. In some implementations, the inner rim 114 may include at least one fillet and/or chamfer. An outer rim 116 may positioned at least partially between the recess 112 and the exterior side surface 110. The outer rim 116 may be flat, curved, and/or any other size, shape, and/or position. The outer rim 116 may extend along an outer perimeter of the recess 112. In some implementations, the outer rim 116 may include at least one fillet and/or chamfer. The outer rim may be configured to prevent embers and/or any other type of debris from falling outside of the fire feature 100. The bottom rim 108 may be position at a bottom perimeter of the formed main body 102 and, in some implementations, the cylindrical body 104. Thus, the bottom rim 108 may be substantially or wholly perpendicular to the exterior side surface 110. The bottom rim 108 may be configured to support the formed main body 102 when the formed main body 102 rests on a surface.

The fire feature 100 may further include a fuel can 120, a lid 122, a base plate 130, and a plate 140. The fuel can may be positioned substantially or wholly in the center of the formed main body 102 and, in some implementations, the cylindrical body 104. In some implementations, the length-wise axis of the fuel can 120 may substantially align with the length-wise axis of the formed main body 102. The fuel can 120 may be positioned entirely between the top surface 106 and the bottom rim 108 or such that at least part of the fuel can 120 extends beyond the top surface 106 or the bottom rim 108. A radius of the fuel can may be less than the radius of the inner rim 114 such that the fuel can may be positioned inside the inner rim 114. The fuel can may be configured to hold fuel and may be configured to contain a flame. In some implementations, the fuel can may be attached to the formed main body 102 such that the fuel can 120 may sit firmly inside the formed main body 102. In some implementations, the fuel can 120 may be attached to the formed main body 102 using any type of attachment such as glue, fasteners, mechanical attachment, and/or adhesive. The fuel can 120 may consist of metal, sheet metal, steel, alloy, ceramic and/or any other material. The fuel can 120 may be configured to couple with a lid 122. The lid 122 may be positioned on the top of the fuel can 120. The lid 122 may be removably coupled to the fuel can 120.

The base plate 130 may be positioned at the bottom of the formed main body 102 and, in some implementations, the cylindrical body 104. In some implementations, the base plate 130 may be removably coupled to the bottom of the formed main body 102. In some implementations, the base plate 130 may be attached to the bottom of the formed main body 102, for example using any type of attachment such as glue, fasteners, mechanical attachment, and/or adhesive. In some implementations, the outer radius of the base plate may be less than or equal to the outer radius of the inner rim 114, the recess 112, the outer rim 116, and/or the cylindrical body 104. The base plate may consist of bamboo, wood, recycled wood, synthetic wood, fiber, metal, sheet metal, steel, alloy, plastic, rubber, ceramic, and/or any other material.

The plate 140 may be positioned on the surface of any surface of formed main body 102. The plate 140 may be positioned on the exterior side surface 110. Thus, the plate 140 may extend from the exterior side surface 110 and may have some length, width, and depth. In some implementations, the length of the plate 140 may be substantially larger than the width and depth of the plate 140. In some implementations, the plate 140 may contain a design, label, logo and/or any other type of depiction. The plate 140 may consist of metal, sheet metal, steel, alloy, plastic, rubber, wood, bamboo, ceramic, and/or any other material. In some implementations, the fire feature 100 may include more than one plate 140.

In some implementations, a cover may be configured to rest on the top surface 106. In some implementations, the cover may be configured to cover an opening of the hole 202 and/or the recess 112.

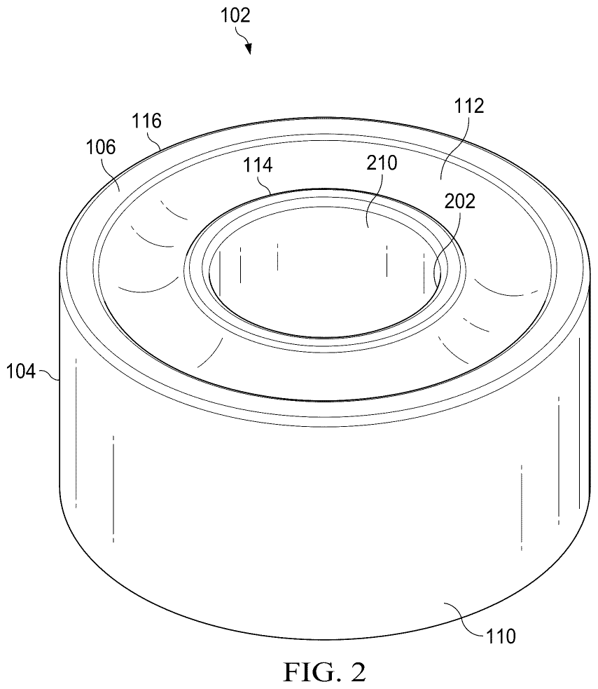

FIG. 2 is a top perspective view of an example formed main body 102, according to some aspects of the present disclosure. The formed main body 102 may further include a hole 202 and an inner surface 210. The hole 202 may extend inwardly from the top surface 106. In some implementations, the hole 202 may only extend partially through the formed main body 102. In some implementations, the hole 202 may extend through the entire formed main body 102. The hole 202, depending on the implementation, may have any cross-sectional shape and/or size, such as circular, elliptical, square, rectangular, triangular, polygonal, and/or any type of complex contour. In some implementations, the hole 202 may have a radius, which may be less than a radius of the formed main body 102, the inner rim 114, the recess 112, the outer rim 116, and/or the cylindrical body 104. In some implementations the recess 112 and/or the inner rim 114 may extend around a top perimeter of the hole 202. The inner surface 210 may extend at least partially along the sides of the hole 202. Thus, the inner surface 210 may be concentric with the exterior side surface 110 and/or may share a length-wise axis with the exterior side surface 110. The inner surface 210 may be substantially or wholly perpendicular to the top surface 106 and the bottom rim 108. In some implementations, the inner rim 114 may be positioned between the recess 112 and the hole 202.

In some implementations, the hole 202 may be configured to contain a fuel can such as the fuel can 120 shown in FIG. 1. The fuel can may be positioned to occupy the entire volume of the hole 202 or only part of the volume of the hole 202. Thus, the fuel can may extend from the top surface 106 to the bottom rim 108 or occupy any space in between. In some implementations, the fuel can may extend past the top surface 106 and/or the bottom rim 108. In some implementations, it may be beneficial for the fuel can to extend past the top surface 106 to allow a user to easily remove and/or replace an unwanted, used, and/or damaged fuel can. In some implementations, the outer radius of the fuel can may be substantially equal to the radius of the hole 202 such that the fuel can fits tightly against the inner surface 210. In some implementations, the radius of the fuel can may be configured with a tolerance relative to the radius of the hole 202 to allow the fuel can to more easily be removed from the hole 202. In some implementations, the fuel can may rest on and/or be supported by a portion of the formed main body 102. In some implementations, the fuel can may rest on and/or be supported by the same surface as the formed main body 102. In some implementations, a second can and/or a second lid may be used to contain the fuel can when placed at least partially inside the hole 202. In some implementations, the second can and/or second lid may be reusable. In some embodiments, the formed main body 102 may be used without a fuel can such that fuel is placed directly inside the hole 202. Examples of fuel include any type of flammable material such as gel fuel, wood, charcoal, coal, propane, compressed natural gas, liquified natural gas, kerosene, petrol, and diesel. It should also be understood that, in some implementations, the hole 202 and/or the formed main body 102 may be used for any other purpose other than to contain a fuel can and/or fuel.

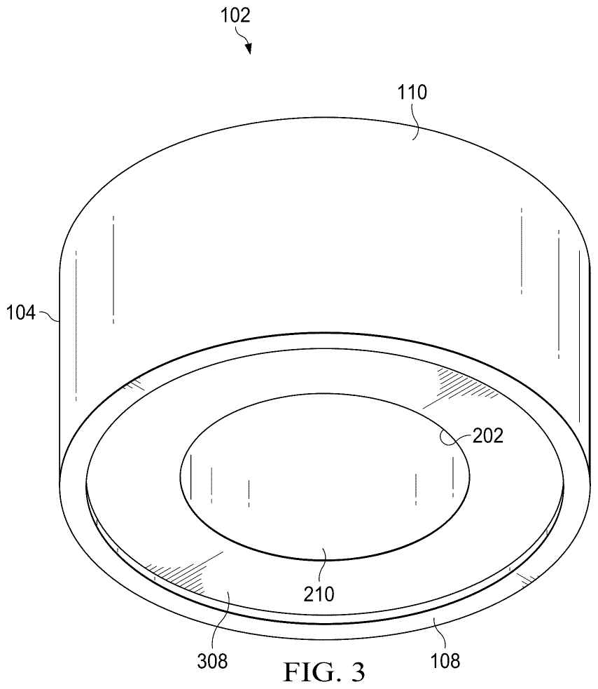

FIG. 3 is a bottom perspective view of an example formed main body 102, according to some aspects of the present disclosure. The formed main body 102 may further comprise a bottom surface 308. The bottom surface 308 may be positioned at the bottom of the formed main body 102 and, in some implementations, the cylindrical body 104. The bottom surface 308 may be substantially or wholly parallel with the top surface 106. The bottom surface 308 may be substantially or wholly perpendicular to the exterior side surface 110. The bottom surface 308 may be substantially adjacent to the bottom rim 108. In some implementations, the bottom surface 308 and the bottom rim 108 may be substantially or wholly parallel. In some implementations, the bottom surface 308 and the bottom rim 108 may be substantially or wholly coplanar. The bottom rim 108 may extend along an outer perimeter of the bottom surface 308 such that an outer perimeter of the bottom rim 108 is substantially or wholly coplanar with the exterior side surface 110. In some implementations, the bottom rim 108 may extend further from the center of the formed main body 102 than the bottom surface 308. In some implementations, a fuel can, such as the fuel can 120 in FIG. 1, may extend from the top surface 106 to the bottom surface 308 or occupy any space in between. In some implementations, the fuel can may extend past the bottom surface 308. In some implementations, the hole 202 may extend inwardly from the bottom surface 308. In some implementations, the inner surface 210 may be substantially of wholly perpendicular to the bottom surface 308. In some implementations, a cross-section may vary in shape and/or area across the height of the formed main body 102 such that the top surface 106 and the bottom surface 308 may have different shapes and/or areas.

In some implementations, a base plate, such as the base plate 130 shown in FIG. 1, may be configured to be removably coupled to the bottom surface 308 and/or the bottom rim 108. In some implementations, the base plate may be configured to be attached to the bottom surface 308 and/or the bottom rim 108, for example using any type of attachment such as glue, fasteners, mechanical attachment, and/or adhesive. Thus, the formed main body 102 may rest on and/or be supported by the base plate when the base plate supports the bottom surface 308 and/or the bottom rim 108. In some implementations, the bottom rim 108 may extend along the sides of the base plate while the base plate is coupled to the bottom surface 308. That is, the bottom surface 308 and the bottom rim 108 may form a concave opening configured to receive the base plate. Thus, in some implementations, an outer radius of the base plate may be substantially equal to an outer radius of the bottom surface 308 and/or an inner radius of the bottom rim 108. In some implementations, the outer radius of the base plate may be configured with a tolerance relative to the inner radius of the bottom rim 108 to allow the base plate to easily be removed from the bottom rim 108.

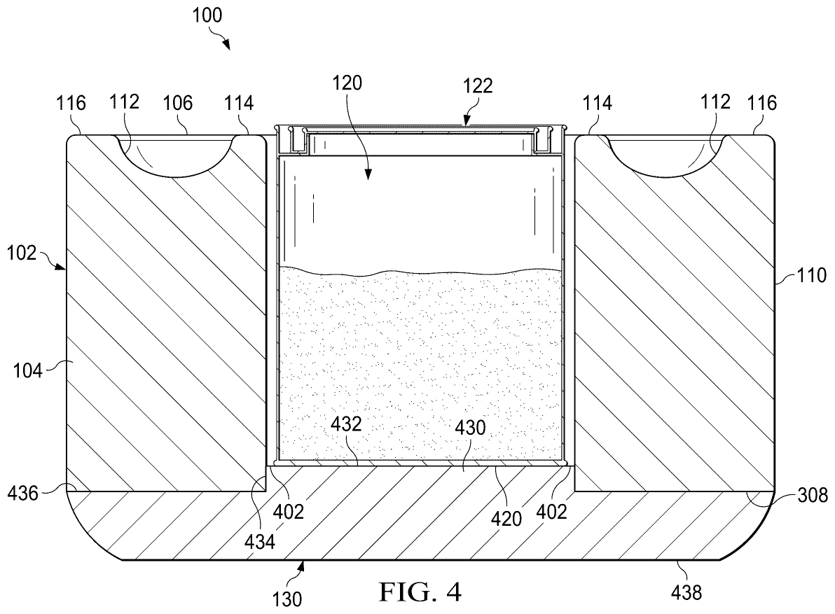

FIG. 4 is a section view of an example fire feature 100, according to some aspects of the present disclosure. In some implementations, the fuel can 120 may be coupled to the base plate 130. Thus, the base plate 130 may be configured to support the fuel can 120 and the fuel can 120 may be configured to rest on the base plate 130. The fuel can may further include a bottom can surface 420 which may couple to the base plate 130. The base plate 130 may further include a top plate surface 436, a bottom plate surface 438, a raised portion 430, a raised surface 432, and a raised side surface 434. The top plate surface 436 may be positioned on the top of the base plate 130 and the bottom plate surface 438 may be positioned on the bottom of the base plate 130. The raised portion 430 may extend a distance from the top plate surface 436 and may be positioned substantially at the center of the top plate surface 436. The raised surface 432 may be positioned at the top of the raised portion 430 and may be positioned a distance from the top plate surface 436 and the bottom plate surface 438. The raised surface may be parallel with the top plate surface 436 and the bottom plate surface 438. The raised side surface 434 may extend along at least a portion of the side of the raised portion 430. Thus, the raised side surface 434 may be substantially or wholly perpendicular to the raised surface 432, the top plate surface 436, and the bottom plate surface 438. In some implementations, the formed main body may be configured with a bottom surface 308 with an outer perimeter adjacent to the exterior side surface 110. In some implementations, the entire bottom surface 308 may couple with the top plate surface 436. In some implementations, the base plate 130 may cover an entire cross-sectional area of the hole 202.

The formed main body may further include an inner ledge 402. The inner ledge 402 may be offset from and/or parallel to the bottom surface 308 and/or the bottom rim 108. The inner ledge 402 may be positioned at the end of the inner surface 210 and may be substantially or wholly perpendicular to the inner surface 210. The raised surface 432 may be configured to removably couple to the inner ledge 402. In some implementations, the raised surface 432 may be attached to the inner ledge 402, for example using any type of attachment such as glue, fasteners, mechanical attachment, and/or adhesive. Thus, in some implementations, the outer radius of the raised surface 432 and the raised portion 430 may be greater than the radius of the inner surface 210 and less than the radius of the exterior side surface 110.

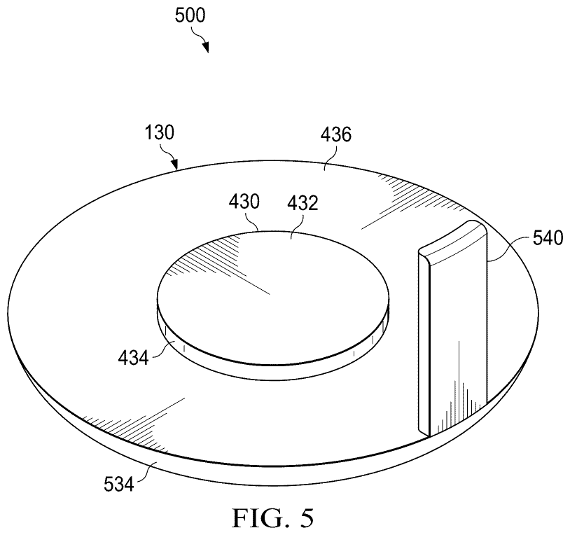

FIG. 5 is a perspective view of an example plate assembly 500, according to some aspects of the present disclosure. In some implementations, the base plate 130 may be further configured to couple with a vertical plate 540 to form a plate assembly 500. The vertical plate may perform similar functions to the plate 140 shown in FIG. 1, such as containing a design, label, logo and/or any other type of depiction. The vertical plate 540 may consist of metal, sheet metal, steel, alloy, plastic, rubber, wood, bamboo, ceramic, and/or any other material. In some implementations, a fire feature may include more than one vertical plate 540. In some implementations, the vertical plate 540 may extend from an exterior side surface, such as the exterior side surface 110 shown in FIG. 1. In some implementations, the vertical plate 540 may be imbedded in an exterior side surface, such as the exterior side surface 110 shown in FIG. 1. In some implementations, the vertical plate 540 may include at least one fillet and/or chamfer and/or the imbedded portion of the exterior side surface may include at least one fillet and/or chamfer. The base plate 130 may further include a side plate surface 534. The side plate surface 534 may extend between the top plate surface 436 and a bottom plate surface, such as the bottom plate surface 438 shown in FIG. 4. In some implementations, the side plate surface may be substantially or wholly coplanar with an exterior side surface, such as the exterior side surface 110 shown in FIG. 1.

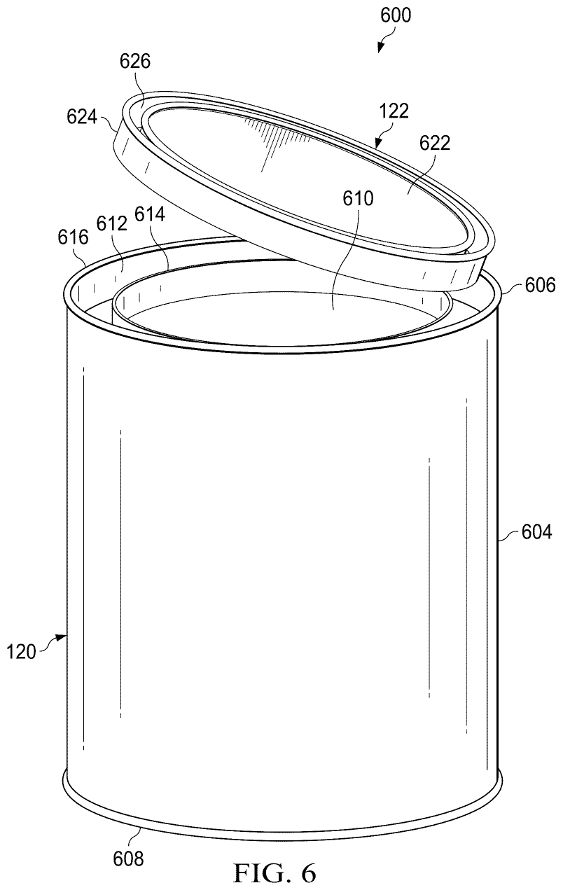

FIG. 6 is a perspective view of an example fuel can assembly 600, according to some aspects of the present disclosure. The fuel can assembly 600 may include a fuel can 120 and a lid 122. The fuel can 120 may further include a can side 604, an upper rim 606, a lower rim 608, and a fuel reservoir 610. The upper rim may further include an upper groove 612, an inner upper rim 614, and an outer upper rim 616. The lid 122 may further include a lid top 622, a lid side surface 624, and a lid groove 626. The lid 122 may be configured to be removably coupled to the upper rim 606. In some implementations, the lid side surface 624 may be inserted into the upper groove 612 to allow the fuel can assembly 600 to reseal. Thus, in some implementations, the lid groove 626 may be sized and shaped such that the lid groove 626 may fit between the inner upper rim 614 and the outer upper rim 616. The lid 122 may be configured to cover the entire fuel reservoir 610 such that the lid 122 may extinguish any flames in the fuel reservoir 610. In some implementations, the fuel reservoir 610 may contain a disposable gel fuel source. Depending on the implementation, the fuel reservoir 610 may contain any type of flammable material such as gel fuel, wood, charcoal, coal, propane, compressed natural gas, liquified natural gas, kerosene, petroleum, and/or diesel.

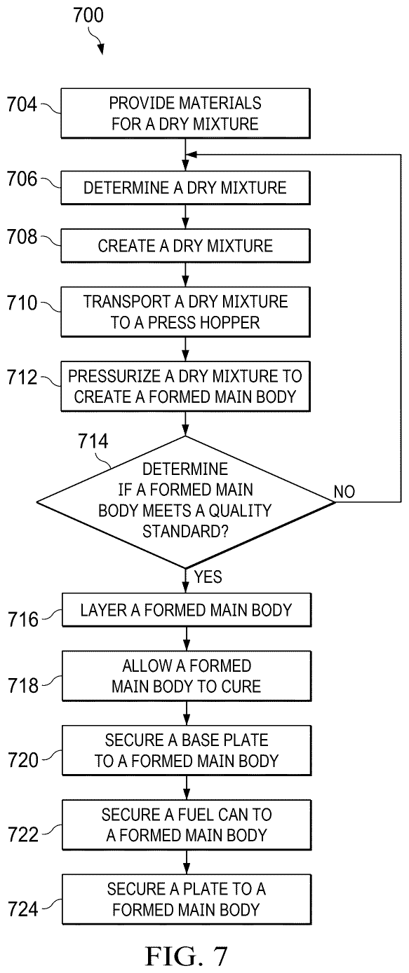

FIG. 7 is an illustrative method 700 for creating a concrete fire feature from a mold, according to some aspects of the present disclosure. Process 704 and process 706 may be completed in a dosing unit. At process 704, materials may be provided for creating at least one dry mixture. It should be understood that, depending on the implementation, any material(s) may be used in creating a mixture for any method disclosed herein. In some implementations, the materials may include limestone, marble, cement, and water. In some implementations, other materials may be used such as dolomite, basalt, granite, gravel, sand, sandstone, asphalt, admixtures, and recycled concrete aggregate. In some implementations, the mixture of initially provided materials may be referred to as an unrefined mixture. For example, the unrefined mixture may include raw limestone and/or raw marble.

At process 706, one or more mixtures may be determined. In some implementations, the material ingredients of a mixture may be determined to attain a desired quality such as decreased setting time and/or higher quality surface finish. In some implementations, an aggregate mixture may be created including at least one aggregate material, such as limestone, marble, and/or any other type of aggregate. In some implementations, marble may be used in the form of marmolina. Aggregate materials generally have an average grain size based on the condition they were mined. The average grain size may correspond to the average size of a grain in the aggregate. An aggregate mixture may include materials at their original grain size and/or materials may be crushed to a smaller grain size to create a finer mixture. Thus, the average grain size of an aggregate mixture may range from the size of large rocks to the size of very fine sand. In some implementations, multiple aggregates and/or multiple aggregate mixtures may be combined to form another aggregate mixture. Multiple aggregates may be combined to form an aggregate mixture with certain desired properties.

In some implementations, a mixture with one average grain size may be combined with another mixture with a different average grain size to form an aggregate mixture. In some implementations a series of one or more meshes may be used to create a mixture of a specific average grain size. For example, an initial mixture may be sorted through a first mesh with A openings per square inch to create a second mixture. A mesh with A openings per square inch may also be referred to as Mesh #A. The second mixture may only have grains small enough to filter through the first mesh. The second mixture may then be sorted through a second mesh with B openings per square inch, where B is greater than A, to create a third mixture. The third mixture may only have grains large enough to not filter through the second mesh. Thus, the third mixture may only have grains small enough to filter through the first mesh and large enough to not filter through the second mesh. A second initial mixture may be sorted through a third mesh with C openings per square inch to create a fourth mixture. The fourth mixture may only have grains small enough to filter through the third mesh. The fourth mixture may then be sorted through a fourth mesh with D openings per square inch, where D is greater than C, to create a fifth mixture. The fifth mixture may only have grains large enough to not filter through the fourth mesh. Thus, the fifth mixture may only have grains small enough to filter through the third mesh and large enough to not filter through the fourth mesh. A proportion of the third mixture and a proportion of the fifth mixture may then be combined to form an aggregate mixture to be used in method 700. In some implementations, the proportion of the third mixture and the proportion of the fifth mixture in the aggregate mixture may be approximately equal. In some implementations, the proportion of the third mixture may be greater than the proportion of the fifth mixture in the aggregate mixture. In some implementations, the proportion of the third mixture may be less than the proportion of the fifth mixture in the aggregate mixture. In some implementations, the proportion of the third mixture may be approximately 60% and the proportion of the fifth mixture may be approximately 40% in the aggregate mixture. In some implementations, C may be less than A and/or D may be greater than A.

For another example, an initial mixture may be sorted through a first mesh with approximately 15-50 openings per square inch to create a second mixture. The second mixture may only have grains small enough to filter through the first mesh. The second mixture may then be sorted through a second mesh with approximately 100-300 openings per square inch to create a third mixture. The third mixture may only have grains large enough to not filter through the second mesh. Thus, the third mixture may only have grains small enough to filter through the first mesh and large enough to not filter through the second mesh. A second initial mixture may be sorted through a third mesh with approximately 5-25 openings per square inch to create a fourth mixture. The fourth mixture may only have grains small enough to filter through the third mesh. The fourth mixture may then be sorted through a fourth mesh with approximately 35-60 openings per square inch to create a fifth mixture. The fifth mixture may only have grains large enough to not filter through the fourth mesh. Thus, the fifth mixture may only have grains small enough to filter through the third mesh and large enough to not filter through the fourth mesh. A proportion of the third mixture and a proportion of the fifth mixture may then be combined to form an aggregate mixture to be used in method 700. In some implementations, the proportion of the third mixture and the proportion of the fifth mixture in the aggregate mixture may be approximately equal. In some implementations, the proportion of the third mixture may be greater than the proportion of the fifth mixture in the aggregate mixture. In some implementations, the proportion of the third mixture may be less than the proportion of the fifth mixture in the aggregate mixture. In some implementations, the proportion of the third mixture may be approximately 60% and the proportion of the fifth mixture may be approximately 40% in the aggregate mixture.

For another example, an initial mixture may be sorted through a first mesh with approximately 30 openings per square inch to create a second mixture. The second mixture may only have grains small enough to filter through the first mesh. The second mixture may then be sorted through a second mesh with approximately 200 openings per square inch to create a third mixture. The third mixture may only have grains large enough to not filter through the second mesh. Thus, the third mixture may only have grains small enough to filter through the first mesh and large enough to not filter through the second mesh. A second initial mixture may be sorted through a third mesh with approximately 16 openings per square inch to create a fourth mixture. The fourth mixture may only have grains small enough to filter through the third mesh. The fourth mixture may then be sorted through a fourth mesh with approximately 40 openings per square inch to create a fifth mixture. The fifth mixture may only have grains large enough to not filter through the fourth mesh. Thus, the fifth mixture may only have grains small enough to filter through the third mesh and large enough to not filter through the fourth mesh. A proportion of the third mixture and a proportion of the fifth mixture may then be combined to form an aggregate mixture to be used in method 700. In some implementations, the proportion of the third mixture and the proportion of the fifth mixture in the aggregate mixture may be approximately equal. In some implementations, the proportion of the third mixture may be greater than the proportion of the fifth mixture in the aggregate mixture. In some implementations, the proportion of the third mixture may be less than the proportion of the fifth mixture in the aggregate mixture. In some implementations, the proportion of the third mixture may be approximately 60% and the proportion of the fifth mixture may be approximately 40% in the aggregate mixture.

In some implementations, average grain size may be determined in ranges including a minimum average grain size value and a maximum average grain size value. For example, a mixture sorted with Mesh #A and Mesh #B (with B >A) may have a range with a minimum value based on the average grain size which fit through Mesh #A and a maximum value based on the average grain size which did not fit through Mesh #B. In some implementations, a mixture may be determined based on more than one range. For example, a second maximum value of a second range may be greater than a first maximum value of a first range, and a second minimum value of the second range may be less than the first maximum value and greater than a first minimum value of the first range.

In some implementations, an aggregate mixture with a lower quartz content may be preferred. Before or after filtering the aggregate mixture based on average grain size, the aggregate mixture may be refined to reduce the percentage of quartz present in the mixture. Aggregate ingredients, such as limestone and marble, may be initially high in quartz content. The percentage of quartz in an aggregate mixture may be any percentage depending on the implementations. In some implementations, the aggregate mixture may contain 0% quartz. In some implementations, the aggregate mixture may contain about 0% quartz. In some implementations, the aggregate mixture may contain 1-2% quartz. In some implementations, the aggregate mixture may contain 1-5% quartz. In some implementations, the aggregate mixture may contain 1-10% quartz. In some implementations, the aggregate mixture may contain 1-15% quartz. In some implementations, the aggregate mixture may contain 1-20% quartz. In some implementations, the aggregate mixture may contain 1-25% quartz. In some implementations, the aggregate mixture may contain about 5% quartz.

In some implementations, a dry mixture may be created to be used in the press to create a formed main body 102. The dry mixture may be referred to as “dry” because of its substantially low water content and/or its high cement content. In some implementations, the dry mixture may contain 1-20% water. In some implementations, the dry mixture may contain 1-15% water. In some implementations, the dry mixture may contain 1-10% water. In some implementations, the dry mixture may contain 1-5% water. In some implementations, the dry mixture may contain 1-2% water. In some implementations, the dry mixture may contain about 4.8% water. In some implementations, the dry mixture may contain 30-95% cement. In some implementations, the dry mixture may contain 25-95% cement. In some implementations, the dry mixture may contain 20-95% cement. In some implementations, the dry mixture may contain 15-95% cement. In some implementations, the dry mixture may contain 10-95% cement. In some implementations, the dry mixture may contain about 15.9% cement. In some implementations, a dry mixture may include approximately 78-81% aggregate mixture, approximately 14-17% cement, and approximately 3-6% water. In some implementations, a dry mixture may include about 79.3% aggregate mixture, about 4.8% cement, and about 15.9% water. Depending on the implementation, one or more types of cement may be used. Depending on the implementation, cement may be any type of cement such as Portland Type III cement.

Process 708 and process 710 may be completed in a mixer unit. At process 708, a dry mixture may be created using some or part of any of the implementations describe herein, such as any implementations described in relation to process 706. Mixing may be completed using a mixing bowl. Mixing may last until the materials are sufficiently mixed into a dry mixture. In some implementations, the dry mixture may be easily poured.

At process 710, the dry mixture may be transported to a press and/or hyperpress. In some implementations, the dry mix is poured into a press hopper.

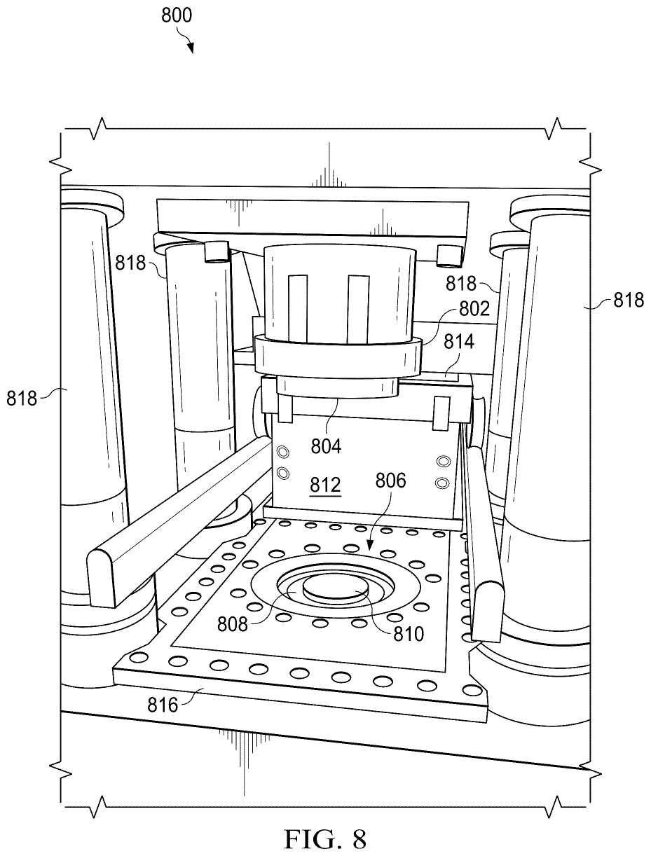

Process 712, process 714, and process 716 may be completed in a press unit. At process 712, a dry mixture may be pressed in a mold to create a formed main body 102. As will be discussed in relation to FIG. 8 included further herein, a press and/or hyperpress may be used to pressurize at least one dry mixture such that a formed main body 102 forms. It should be understood that any type of press and/or device may be used to transform at least one dry mixture into a formed main body and that any press and/or device described herein is merely an example. It should also be understood that a formed main body produced by a method 700 may be any size, shape, and/or form and that the implementations described in FIGS. 1-4 are merely examples.

At optional process 714, the formed main body 102 may be assessed to determine if the product meets a specified quality standard. A specified quality standard may be assessed as the minimum expectation of the quality of the surface finish of an outer surface of the formed main body 102. In some implementations, a specified quality standard may be required to be met for a product to be acceptable for sale. In some implementations, the entire surface area of the formed main body may be referred to as an outer surface. Ideally, the prior processes 702-12 will create a formed main body 102 which may be converted into a final product without further surface finishing. Generally, concrete pieces with large holes on the surface require additional finishing for the surface to be determined acceptable. Quality of surface finish may be determined in a number of ways. In some implementations, porosity may be used to determine if the formed main body 102 meets the specified quality standard. For example, in some implementations, a porosity of 1-40% may be required for an acceptable product. In some implementations, a porosity of 1-50% may be required for an acceptable product. In some implementations, a porosity of 1-30% may be required for an acceptable product. In some implementations, a porosity of 1-20% may be required for an acceptable product. In some implementations, a porosity of 1-15% may be required for an acceptable product. In some implementations, a porosity of 1-10% may be required for an acceptable product. In some implementations, a porosity of 1-9% may be required for an acceptable product. In some implementations, a porosity of 1-5% may be required for an acceptable product. In some implementations, a porosity of 1-2% may be required for an acceptable product.

In some implementations, average peripheral hole size on the outer surface may be used to determine if the formed main body 102 meets the specified quality standard. For example, in some implementations, an average peripheral hole size of 0 to ⅛ inches may be required for an acceptable product. In some implementations, an average peripheral hole size of 0 to 1/16 inches may be required for an acceptable product. In some implementations, an average peripheral hole size of 0 to 1/32 inches may be required for an acceptable product. In some implementations, an average peripheral hole size of 0 to 1/64 inches may be required for an acceptable product. If a formed main body 102 does not meet the specified quality standard, the method 700 may return to process 706. Thus, if the method returns to process 706, a second formed main body may subsequently be created with changes and/or improvements based on the formed main body 102.

In some implementations, a measurement of surface roughness may be used to determine if the formed main body 102 meets the specified quality standard. Depending on the implementation, surface roughness may be measured a number of ways based on any industry standard such as the ASME Y14.36M standard and/or the ISO 21920-1:2021 standard. For example, surface roughness may be assessed based on an average of profile height deviations from a mean line (Ra) measured in microinches. Thus, an Ra value may be provided to be used to determine if a formed main body 102 is acceptable.

It should be understood that any type of measurement which may be used to measure surface finish may be used to assess the surface finish of a formed main body 102.

In some implementations, if the porosity is less than specified percentage value, the average peripheral hole size of an outer surface is less than a specified value, an Ra value is less than a specified value, and/or any other standard for determining an acceptable surface finish is satisfied, an outer surface of the formed main body 102 may be referred to as “smooth.”

At optional process 716, a formed main body 102 may be layered as part of a vertical configuration with at least one other formed main body 102. Layering may include placing at least two formed main bodies 102 in a vertical configuration, such as on shelves. In some implementations, the vertical configuration may allow for quicker curing and/or decrease the area required for curing.

At optional process 718, the formed main body 102 may be allowed to cure. In some implementations, curing may take place in a greenhouse. In some implementations, the greenhouse may potentially decrease the time period required for curing. While hyperpressed pieces are generally set, hardened, and/or able to be handled a short time period after being pressed, additional curing time may be useful to allow the formed main body 102 to harden fully and strengthen. In some implementations, a formed main body may cure in 1-24 hours. In some implementations, a formed main body may cure in more than 24 hours. In some implementations, a formed main body may cure in 1-48 hours. Placed in some temperatures, a formed main body 102 may generally cure in 1-24 hours. Placed in some temperatures, a formed main body 102 may generally cure in 1-48 hours. In some embodiments, if the average external temperature is higher than the average temperature of the formed main body 102, the curing process may potentially occur more quickly. In some implementations, artificial heating, such as greenhouses, heat lamps, electric heaters, and any other type of artificial heating, may be used to decrease the curing time period.

At processes 720, 722, and 724, the fire feature 100 may be assembled by adding additional components to the formed main body.

At optional process 720, A base plate 130 may be secured to the formed main body. The base plate 130 may be secured to the bottom surface 308 and/or the bottom rim 108.

At optional process 722, A fuel can 120 may be secured at least partially inside the hole 202.

At optional process 724, A plate 140 may be secured to any external surface of the formed main body 102, such as the exterior side surface 110.

It should be appreciated that any of the steps of method 700 may be completed in any order. It should also be appreciated that some or all optional steps may be completed depending on the embodiment. The order of the steps in method 700 may be changed indiscriminately as manufacturing creates a fire feature 100.

FIG. 8 is a perspective view of an example press 800, according to some aspects of the present disclosure. The formed main body 102 may be created using the hyperpress 800. The hyperpress may include a presser 802, a pressing plate 804, a mold 806, a lower plate 808, and a mold center 810, a press hopper 812, a bottom plate 816, and supports 818. The press hopper may contain a dry mixture 814. First, the press hopper 812 may extend forward such that it is above the bottom plate 816. Then, the dry mixture 814 drops into the mold 806. The lower plate 808 may lower to allow the dry mixture 814 to enter the mold 806. In some implementations, the press hopper 812 may oscillate across the bottom plate 816 to more effectively drop the dry mixture 814 into the mold 806. Then, the press hopper may be drawn back off of the bottom plate 816 such that the top of the mold 806 is exposed. Then, the presser 802 may drop down such that the pressing plate 804 is adjacent to the dry mixture. In some implementations, the pressing plate 804 may press into the dry mixture and/or apply pressure to the dry mixture. In some implementations, the pressing plate may form a recess 112 in the dry mixture. In some implementations, the mold center 810 may be configured to end at an elevation higher than the lowest elevation of the lowest portion of the pressing plate 804 such that a hole 202 may extend entirely through the formed main body 102. In some implementations, the mold center 810 may be configured to end a distance away from the lowest elevation of the pressing plate 804 such that a hole 202 does not extend entirely though the formed main body 102. Then, pressure may be applied to the dry mixture from the lower plate 808 such that a formed main body 102 forms. In some implementations, the amount of pressure applied to the dry mixture is approximately 1-50 bar. In some implementations, the amount of pressure applied to the dry mixture is approximately 30-35 bar. In some implementations, the amount of pressure applied to the dry mixture is about 32 bar. In some implementations, the amount of pressure applied to the dry mixture is about 30 bar. In some implementations, the presser 802 and/or the pressing plate 804 may apply pressure to the dry mixture. Then, the presser 802 and the pressing plate 804 may raise and the lower plate 808 may elevate the formed main body 102 above the mold. In some implementations, the formed main body 102 may have a finished surface such that the formed main body may be handled directly or shortly after being raised from the mold 806. The supports 818 may support the presser 802 and/or the pressing plate 804. In some implementations, the supports 818 may be configured to raise and/or lower the presser 802 and/or the pressing plate 804.

In some implementations, the orientation of the mold 806 may be inverted such that the top surface 106 of the created formed main body 102 faces downwardly. In this configuration, the lower plate 808 may be configured to create a recess 112 in the top surface 106 of the formed main body and/or the pressing plate 804 may be configured to create a bottom surface 308 and/or a bottom rim 108 on the formed main body 102. In some implementations, for the inverted configuration(s), the mold center 810 may be configured to end at an elevation higher than the lowest elevation of the lowest portion of the pressing plate 804 such that a hole 202 may extend entirely through the formed main body 102. In some implementations, for the inverted configuration(s), the mold center 810 may be configured to end a distance away from the lowest elevation of the pressing plate 804 such that a hole 202 does not extend entirely though the formed main body 102.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the stove and stand system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

Persons skilled in the art will recognize that the apparatus, systems, and methods described above can be modified in various ways. Accordingly, persons of ordinary skill in the art will appreciate that the embodiments encompassed by the present disclosure are not limited to the particular exemplary embodiments described above. In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

What is claimed is:

1. A method of creating a concrete fire feature with a mold, the method comprising:
creating an aggregate mixture by combining a first mixture with an average grain size within a first range and a second mixture with an average grain size within a second range, the aggregate mixture comprising about 5% quartz or less;
creating a dry mixture comprising an aggregate mixture proportion of the aggregate mixture, a cement proportion of cement, and a water proportion of water, the water proportion comprising about 15% or less of the dry mixture;
pressurizing the dry mixture to create a formed main body having an outer surface with a porosity of about 40% or less, the formed main body comprising a top surface, a bottom surface, and a hole extending inwardly from the top surface or the bottom surface;
curing the formed main body outside the mold; and
securing a fuel can at least partially inside the hole.

2. The method of claim 1, wherein the formed main body further comprises a cylindrical body and a bottom rim extending around an outer perimeter of the bottom surface; and the top surface further comprises a recess extending around a top perimeter of the hole.

3. The method of claim 1, comprising securing a base plate to the bottom surface without further finishing the formed main body,
wherein the hole extends from the top surface to the bottom surface; the base plate covers an entire cross-sectional area of the hole; and the fuel can is supported by the base plate, the fuel can configured for a lid to rest on an upper rim of the fuel can.

4. The method of claim 1, wherein a second maximum value of the second range is greater than a first maximum value of the first range, and a second minimum value of the second range is less than the first maximum value and greater than a first minimum value of the first range.

5. The method of claim 1, wherein the water proportion comprises about 5% or less of the dry mixture.

6. The method of claim 1, wherein the cement proportion comprises about 15% or more of the dry mixture.

7. The method of claim 6, comprising elevating the formed main body out of the mold.

8. The method of claim 2, wherein the top surface further comprises an inner rim extending along an inner perimeter of the recess and an outer rim extending along an outer perimeter of the recess.

9. The method of claim 1, wherein the formed main body further comprises:
an inner surface extending along at least a portion of the inside of the hole; and
an inner ledge substantially perpendicular to the inner surface and facing downwardly.

10. The method of claim 9, comprising securing a base plate to the bottom surface without further finishing the formed main body, wherein the base plate further comprises a raised portion, the raised portion being positioned in the center of the base plate, the raised portion being configured to support the fuel can and configured to couple with the inner ledge.

11. The method of claim 1, comprising securing a base plate to the bottom surface less than 24 hours after removing the formed main body from the mold.

12. The method of claim 1, wherein the dry mixture further comprises a limestone proportion of limestone and a marble proportion of marble.

13. The method of claim 1, wherein the curing further comprises curing the formed main body outside the mold at an average temperature more than an average temperature of the formed main body.

14. The method of claim 1, wherein the applying pressure to the dry mixture further comprises applying at least 30 bar of pressure to the dry mixture.

15. A method of creating a concrete fire feature, the method comprising:
creating an unrefined mixture comprising a proportion of limestone and a proportion of marble;
removing grains outside a first grain-size range from the unrefined mixture to obtain a first mixture, the first mixture comprising no more than 5% quartz;
removing grains outside a second grain-size range from the unrefined mixture to obtain a second mixture, the second mixture comprising no more than 5% quartz;
creating a dry mixture comprising a proportion of the first mixture, a proportion of the second mixture, a proportion of cement, and a proportion of water, the proportion of water comprising no more than 10% of the dry mixture;
applying pressure to the dry mixture in a mold to create a formed main body, the formed main body having a smooth outer surface with an average peripheral hole size of less than ⅛ inches, the formed main body comprising a top surface, a bottom surface, and a hole extending inwardly from the top surface or the bottom surface;
curing the formed main body outside the mold; and
securing a fuel can at least partially inside the hole.

16. The method of claim 15, comprising securing a base plate to the bottom surface without further finishing the formed main body,
wherein the hole extends from the top surface to the bottom surface; the base plate covers an entire cross-sectional area of the hole; and the fuel can is supported by the base plate, the fuel can configured for a lid to rest on an upper rim of the fuel can.

17. The method of claim 15, wherein the formed main body further comprises a cylindrical body and a bottom rim extending around an outer perimeter of the bottom surface; and the top surface further comprises a recess extending around a top perimeter of the hole.

18. The method of claim 15, comprising securing a base plate to the bottom surface less than 24 hours after removing the formed main body from the mold.

19. The method of claim 15, wherein the proportion of water comprises about 5% or less of the dry mixture.

20. The method of claim 15, wherein the proportion of cement comprises about 15% or more of the dry mixture.

21. A method of creating a concrete fire feature with a mold, the method comprising:
creating an aggregate mixture by combining a first mixture with an average grain size within a first range and a second mixture with an average grain size within a second range, the aggregate mixture comprising a quartz proportion comprising no more than 5% quartz;
creating a dry mixture comprising an aggregate mixture proportion of the aggregate mixture, a cement proportion of cement, and a water proportion of water, the water proportion comprising no more than 10% of the dry mixture;
pressurizing the dry mixture to create a formed main body from the mold, the formed main body comprising a top surface, a bottom surface, and a hole extending inwardly from the top surface or the bottom surface;
determining that the formed main body does not have a smooth outer surface or a porosity of no more than 40%;
decreasing the average grain size in the first mixture or the second mixture;
reducing the quartz proportion or the water proportion in the dry mixture; and
pressurizing the dry mixture to create a second formed main body.

22. The method of claim 21, wherein the formed main body further comprises a cylindrical body and a bottom rim extending around an outer perimeter of the bottom surface; and the top surface further comprises a recess extending around a top perimeter of the hole.

23. The method of claim 21, comprising securing a base plate to a second bottom surface of the second formed main body less than 24 hours after removing the second formed main body from the mold or a second mold.

24. The method of claim 21, wherein the water proportion comprises about 5% or less of the dry mixture.

25. The method of claim 21, wherein the cement proportion comprises about 15% or more of the dry mixture.
